(19) United States
(12) Patent Application Publication
(10) Pub. No.: US 2015/0227967 A1
(43) Pub. Date: Aug. 13, 2015

(54) UNIFIED SOCIAL MEDIA CAMPAIGN MANAGEMENT

(71) Applicant: John J. Bojan, (US)

(72) Inventors: Darrell E.A. Knight, Atlanta, GA (US); John J. Bojan, Littleton, CO (US)

(21) Appl. No.: 14/621,386

(22) Filed: Feb. 13, 2015

Related U.S. Application Data
(60) Provisional application No. 61/939,346, filed on Feb. 13, 2014.

(51) Int. Cl. G06Q 30/02

(52) U.S. Cl. CPC G06Q 30/0246; G06Q 30/0261; G06Q 50/01

(57) ABSTRACT

This disclosure pertains to a Multi-Location focused cloud based computer system and methods, which can be White Labeled, for creating, conducting, managing, monetizing and gauging the effectiveness of Social Media Marketing Campaigns across all content deployed to one or more social networks. The key components consists of Social messages, a time zone aware automated scheduling and posting module, an internal responsive Landing page builder and ‘plug-ins’ for use with external builders and Unified Metric System all managed from a Dashboard having Multi-Location Campaign management features. Together the components are referred to as Buzzes. A Campaign can have one or more Buzzes. The Unified Metrics System continuously tracks Follower Actions across all content then places them against a value matrix calculating a single effectiveness score called the BuzzScore. These components, in other systems, are typically disparate and require cobbling together multiple reports from various networks and web pages to determine effectiveness.

### PRIORITY CLAIM

This application claims priority under 35 U.S.C. 119(e) of U.S. Provisional Application Ser. No. 61/939,346 filed Feb. 13, 2014, the contents of which are hereby incorporated by reference.

### FIELD OF THE DISCLOSURE

In general this disclosure relates to software in the digital marketing space, particularly for creating, conducting, managing and monetizing social media marketing campaigns supporting a multi-tier, multi-location business model where customers, such as Franchisors, Agencies and large Brands dealing with the challenges of multi-location marketing.

### BACKGROUND OF THE DISCLOSURE

Mobile and Social Media technology has transformed the traditional mix of advertising and marketing channels, Print-TV-Direct Mail-etc., with Social Media Marketing firmly taking its place in corporate marketing. This shift has created the need and desire for tools that unify and automate creating, conducting, managing, monetizing and gauging the effectiveness of full function social marketing campaigns especially in a multi-location setting. Full function Campaigns include Landing pages which are proven to increase conversion and effectiveness.

If the Campaign communications contain disparate content it makes effectiveness tracking extremely difficult, if not impossible due to unknown relationships contained and managed within social networks. A common practice is to include links in social posts to external content, such as a Landing page known to increase effectiveness but can also form a disconnect to analytics and tracking especially when users share to their followers. The act of sharing, especially simultaneously to multiple networks can cause an overload, disconnect and significantly complicate content management to the point where it is not possible. The problem is magnified for businesses involved in multi-tier multi-location business models such as Agencies, Franchisors or Large Brands where multiple divisions, clients and or locations exist.

This disclosure tracks, manages, automates and solves these problems by providing unified content, permissions, metrics and computing structure for content creation, management and tracking tools across all content resulting in a single easy to understand effectiveness score referred to as a BuzzScore.

Where multi-locations are involved the Disclosure has the ability to Clone entire Campaigns and Buzzes which fully duplicates and synchronize location specific data to internal profiles and other integrated operating data systems to access required information such as pricing, images, addresses, phone numbers, contact names, etc. This unique tracking method makes the important act of social media sharing among computers and servers meaningful and useful.

### BRIEF SUMMARY OF DISCLOSURE

The software of this Disclosure operates in the Cloud specifically to execute programs to process the act of creating, conducting, managing and monetizing social media marketing campaigns to popular social networks such as Facebook, Twitter and the like. A typical social media marketing campaign includes one or more communications to social followers in various social networks. In this disclosure these communications are referred to as Buzzes and they are assigned to one or more Campaigns. A Buzz can have multiple configurations consisting of Social posts containing text messages and image content selectively linked to Landing pages which boost conversion by providing the real estate to fully document the campaigns purpose and or cause including calls to actions known to increase campaign effectiveness and conversion.

There is a central user interface for the software, referred to as the Dashboard, which presents various data, related graphics and functionality pertaining to orchestrating and administration of Campaigns in a multiple location setting such as accounts, locations, users, content creation, best practices and managing performance. Governing access to functionality is a security schema which includes logins, passwords and a Hierarchy of Permissions that is integrated to a multi-tier business model system supporting multi-location marketing for Partners, Clients, Locations and Users. An example of the multi-tier multi-location opportunity would be Franchisor marketing for Franchisees which typically need to localize marketing. In the system the Franchisor would be a Partner who can create landing page Templates and campaigns for Clients such as the Franchisee however Clients can only edit certain elements of the landing pages and can't perform campaign services for Partners.

The software of this Disclosure is built to be ‘white labeled’ by business partners such as Franchisors and Agencies dealing with the challenges of multi-location marketing. Therefore a robust Hierarchy of Permissions is integrated into the Disclosure's Landing page Template Cloud, location profiles, unified metrics and Dashboard was engineered to facilitate efficient and accurate tracking of metrics within and across all content especially when users share within social networks.

The Disclosure's Landing pages can be built internally or externally, generated manually or automatically and are based on responsive web technology to provide optimum viewing from any internet connected device. When built externally the Disclosures Landing page ‘plug-in’ is used to designate content for tracking and editing. The Disclosures Landing pages contain brand control functions which lock down and prevent editing or deleting of brand related elements by lower level users. The content of the Landing pages can be static or dynamic from data feeds and or other integrated operating data systems such as MLS, eCommerce and the like.

When deploying Buzzes or Campaigns to multiple locations, location specific variable data in the landing pages or social posts can be automatically updated upon deployment from internal location profiles and or external systems making deployment of large campaigns covering multiple locations easy and efficient.

The Disclosures unified metric system calculates effectiveness by putting collected statistics against a value matrix yielding a unique Effectiveness score, referred to as the BuzzScore which, in part, also contains generally accepted marketing metrics such as Reach, Engagement and Conversion. The BuzzScore is then rolled up to the Campaign, Location, Client and Partner levels for evaluating and promoting best practices.

### DESCRIPTION OF FIGURES

FIG. 1 shows the general flow of process of creating a social media campaign thru to the generation of a BuzzScore.

FIG. 2 provides a pictorial view of the content created by the software and would be received by a Social Media follower of the Brand.

FIG. 3 is the layout of the computer network and major components of the software.

FIG. 4 presents the Architecture of the Template Cloud.

FIG. 5 shows a Partners view of the main Dashboard displaying statistics and graphics for Effectiveness, Reach, Engagement and Conversion on a consolidation basis for a particular Client relative to campaign activity.

FIG. 6 is the Dashboards View/Edit pull down menu.

FIG. 7 shows the Accounts screen of the Dashboard.

FIG. 8 is the Dashboards Settings pull down menu.

FIG. 9 shows the Campaigns screen of the Dashboard displaying the status of one Campaign with the BuzzScore and one Buzz under it deployed to Twitter. Below the Buzz line is displayed the contents of the Buzz. Operational Icons with the Clone icon highlighted are followed by the Dialog box for redeploying a Cloned Campaign to one or more locations.

FIG. 10 shows an example of the steps involved in creating and scheduling a Buzz with the ability to deploy it to multiple locations. A mobile rendition of the Landing page is shown to the right.

FIG. 11 the Dashboard screen for managing and loading in Content to the Disclosures Libraries.

FIG. 12 shows another example of creating a Buzz. In this case the Buzz is specifically for the Campaign under which the Create Buzz Icon is activated.

FIG. 13 shows the internal Landing page Template Builder.

FIG. 14 shows how a Landing page is displayed with editable elements highlighted in some fashion, in this illustration they are in dark borders.

FIG. 15 shows the Landing page of FIG. 14 repurposed for another campaign.

FIG. 16 shows landing page of FIG. 15 with an example of the static image replaced with a dynamic feed from a backend system such as eCommerce.

FIG. 17 shows the BuzzScore caption image which displays the effectiveness score from the platforms proprietary value and effectiveness ranking system.

FIG. 18 shows an illustration of the BuzzScore weighting system.

FIG. 19 shows an embodiment of the computer and network architecture.

FIG. 20 shows an embodiment of the computer and network architecture.

FIG. 21 shows the Dashboards Location screen for managing locations.

FIG. 22 shows the Location Profile screen used for location specific data.

FIG. 23 shows an example of a screen after querying for Clients where BuzzScore performance is shown along with locations, campaign activity and a place holder for display Tag data.

FIG. 24 shows the Disclosures WordPress Plug-in on a section of the WordPress side bar menu which is use for setting the BuzzScore system to track elements of WordPress content.

FIG. 25 shows the Disclosures WordPress Plug-in on a section of the WordPress side bar menu which is use for selecting Landing pages in this case under the Buzzigo brand.

FIG. 26 shows an illustration of the Disclosures WordPress Plug-in listing track-able elements in frames on a WordPress web Page and a list of items for selective tracking.

FIG. 27 shows WordPress Template with editable items framed and a text editing tool.

FIG. 28 shows the Systems schema for the Hierarchy of Permissions.

### DETAILED DESCRIPTION OF THE DISCLOSURE

The present Disclosure is a novel Cloud based multi-tenant multi-location capable computer software system which unifies and integrates the components and methods for creating, conducting, managing, monetizing and gauging the effectiveness across all content of social media marketing campaigns to multiple social networks. Responsive web technology is used for content providing optimal viewing on mobile phones, tablets and desktop devices.

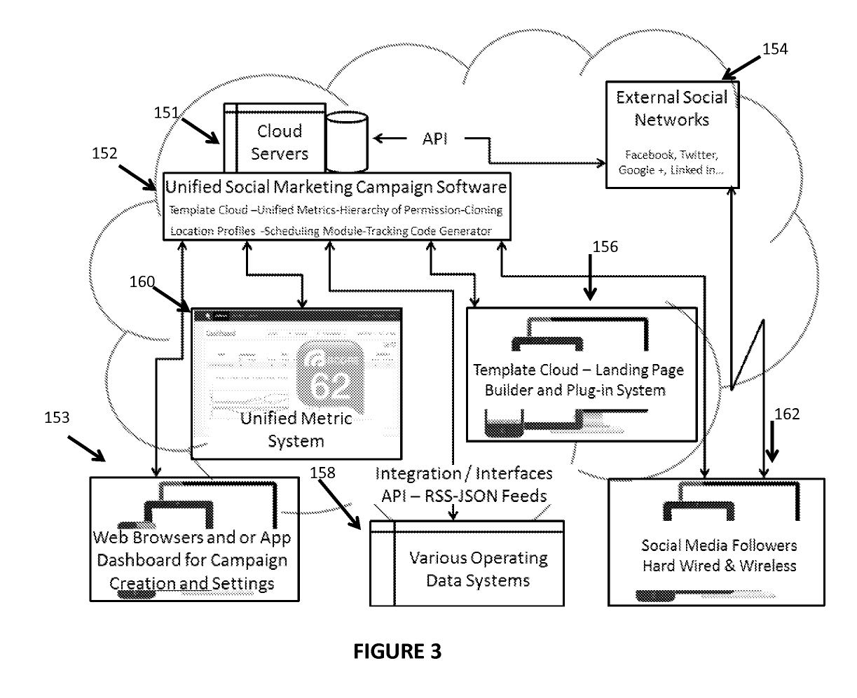

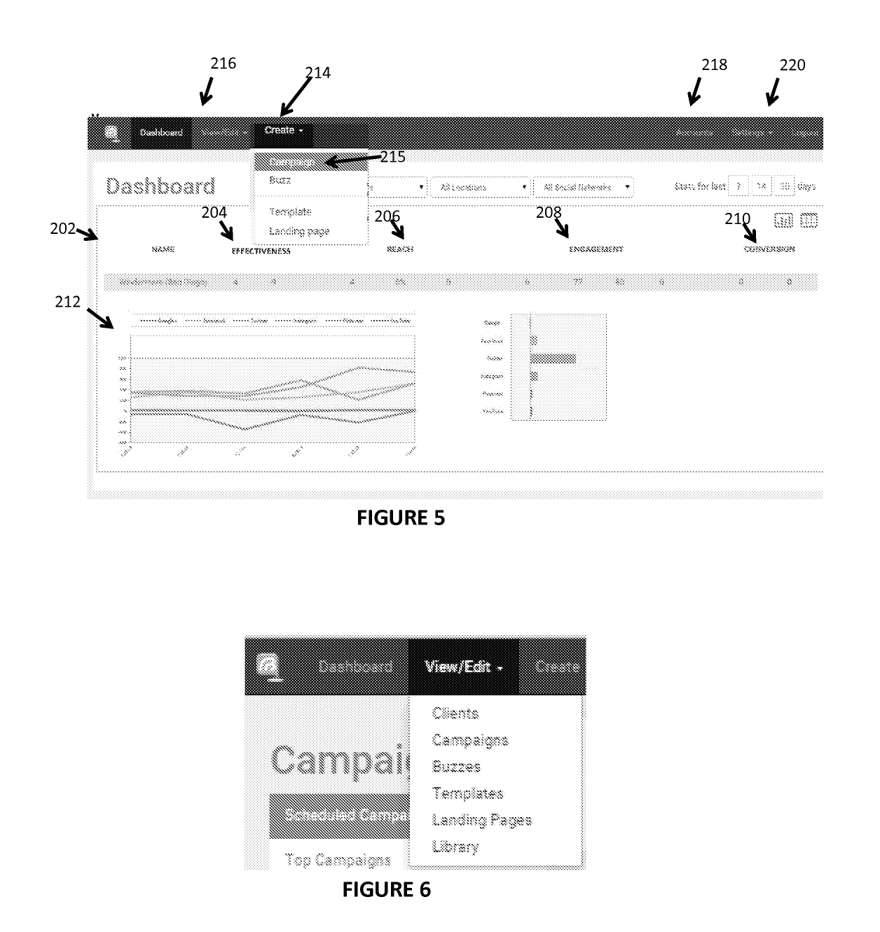

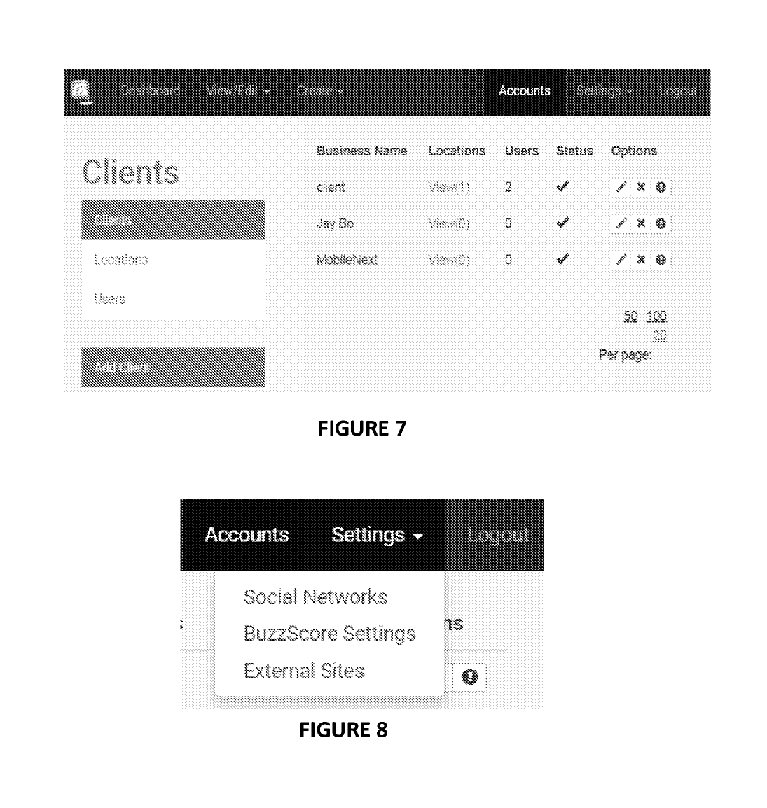

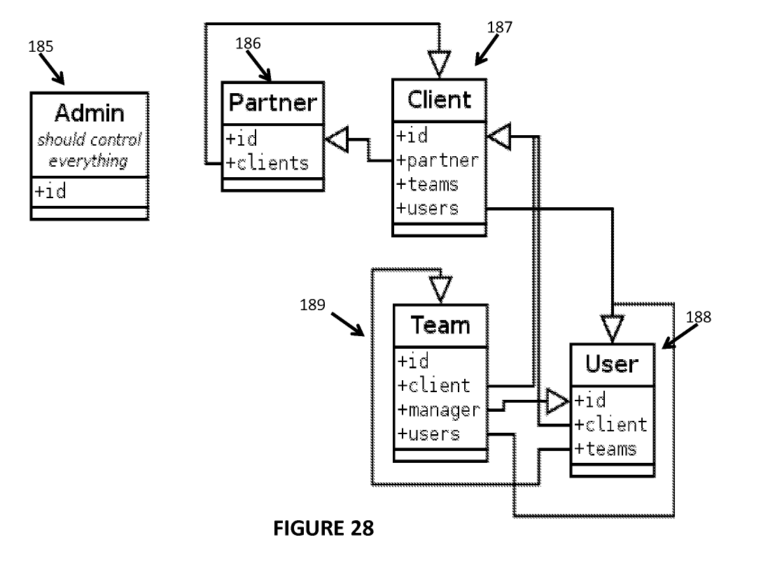

Upon entering the software the main Dashboard screen is displayed as shown in FIG. 5. The purpose of the Dashboard is to easily navigate all aspects of the software to orchestrate and administrate social media marketing campaigns to multiple social networks, Clients and Locations with one system. Governing access to functions in the Dashboard is the Disclosures Hierarchy of Permissions which seamlessly guides access to Dashboard screens and functionality by filtering data and functions which correlate to the level of permissions associated with the logged in user. The Hierarchy of Permissions also governs the functionality of other operating units. The Schema is presented in FIG. 28 where the Software of FIG. 3 item 152 sends instructions to the Server item 151 to programmatically provide system content, such as screen views, menus and functions in relation to the users level of permissions. An example of the tenant schema is shown in FIG. 28 where the Administrator, item 185 controls all aspects of the system and sets up Partners, Clients, Users and more. The steps of which consist of an Administrator selecting Accounts then Add Client as in FIG. 7 which establishes the setting in Software item 152 which then sends instructions to the Server item 151 to communicate with the database to establish the Account and all associated links and unique identifiers. Similar operations are followed for setting up Partners Locations Users, Teams. Partners in FIG. 28 item 186 can create Templates for Landing pages and can set up lower level permissions such as Clients 187 who can edit Landing pages and can have multiple Users 188 who belong to Teams 189. As example, a Franchisor established as Partner can create Landing page Templates and Campaigns for Clients such as a Franchisee. However Clients can even see the Create Campaign Template functions and can only edit certain elements of the Landing pages, not structure and can't perform campaign services for Partners.

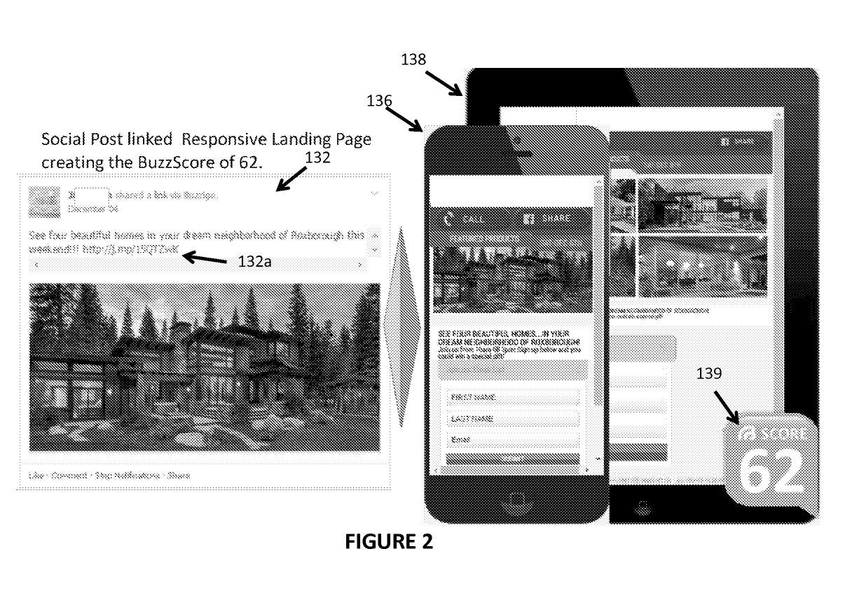

As shown in the main view of the Dashboard of FIG. 5 a Client performance is consolidated into one line 202 for all Campaigns. There are several metrics being displayed such as the Disclosures unique Effectiveness score referred to as a BuzzScore 204 which is comprised of Reach 206, Engagement 208 and Conversion 220 and proprietary algorithms. Below the 202 Client listing section are performance graphics which depict the metrics above for each highlighted Client in section 222. These metrics are the collective results of the Unified Metric System FIG. 3 item 160 gathering data regarding user actions from within and across all campaign content Followers experience as shown in FIG. 2 where a Follower would receive a Social post item 132, linked, item 132a to Landing pages items 136 and or 138 depending on the device used to the BuzzScore 139. The BuzzScore is an effectiveness rating that ranges from zero to one hundred.

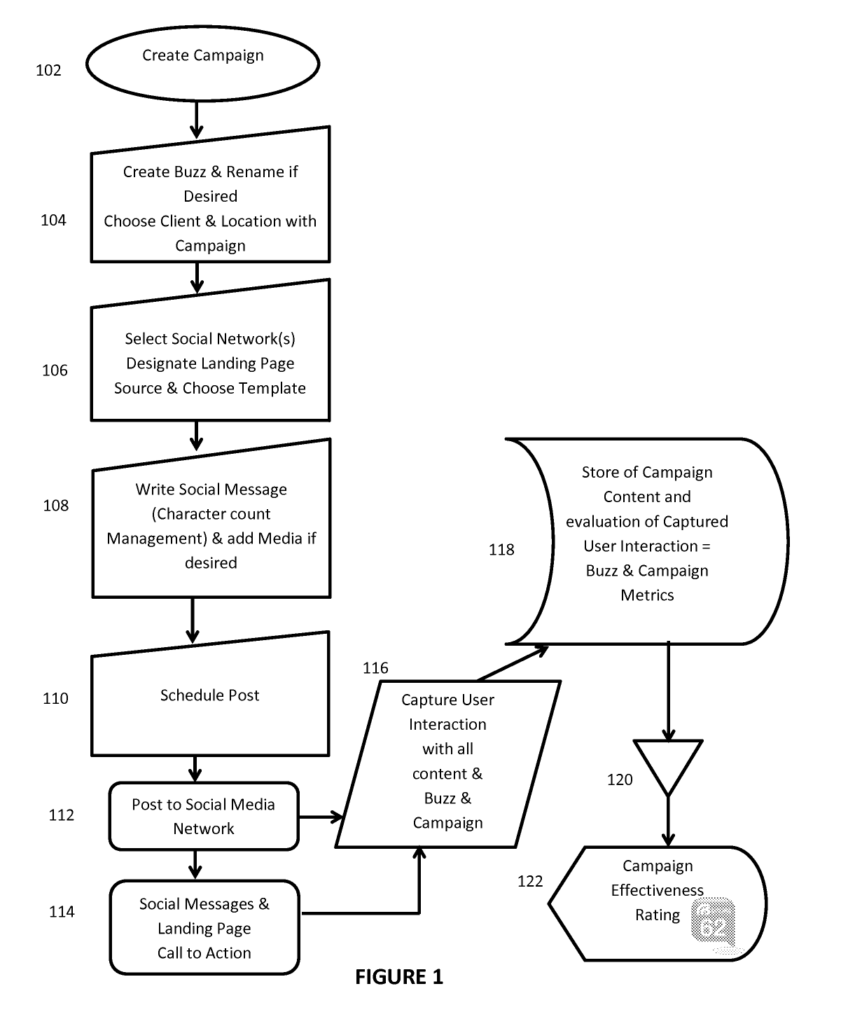

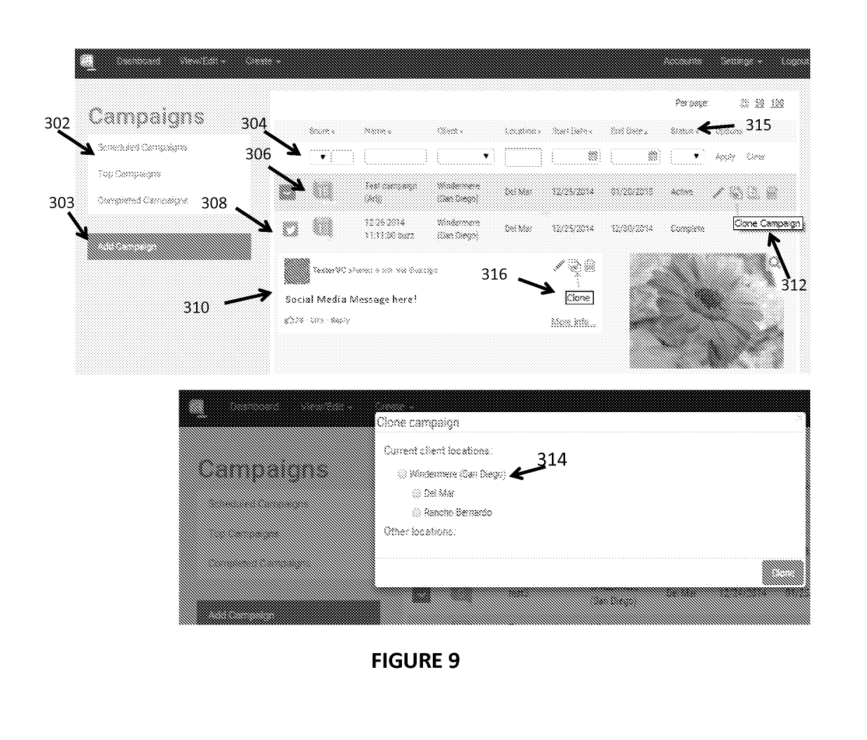

FIG. 1 shows the general flow of the software relative to creating social media campaigns, item 102. The process generally starts by creating a Campaign which can be done by accessing the Campaign Dashboard shown in FIG. 5 then select the Create menu 214 and Campaigns, item 215. In FIG. 9, the Campaigns Dashboard, one can filter using filters in item 304. Campaigns are displayed as shown in item 306 with shown under the Campaign and indented as shown in item 308 with the icon of Social Network the Buzz is to be posted to ie. Twitter as shown. Once the Campaign Dashboard screen of FIG. 9 is displayed select Add Campaign, item 303. Note security can be set on Buzzes and Campaigns such that a Location Manager must approve each by changing the Status from Draft to Active in order to Post. Alerts are sent to the Manager of record that Campaign content needs approval. As an aid to the users the Campaign view can be sorted thru the filters 304 to see Campaigns and data in various states such as specific clients plus Top Campaigns in the 302 section. Relative to Campaign creation, if it is desired to use a proven Campaign then one would Clone a Campaign by highlighting the desired Campaign, select the Clone icon indicated by item 312 followed by assigning it to a Client or Clients and Location(s) as shown in item 314. The Disclosure then duplicated all elements of the Campaign and uniquely identify it and all connections and relationships so it can be redeployed as directed. These relationships are maintained when shared among followers unknown to the system which continues to track user actions across the content.

Cloning can also be done at the Buzz level, when it is desired to use a successful Buzz from another Campaign, versus creating one from scratch. To achieve this, one would navigate to a Campaign, highlight the Buzz which displays the section item 310 in FIG. 9 and select the Clone icon item 316. The software would then Clone the Buzz by duplicating all components and elements to the database for it to be assigned to a Campaign in a fashion similar to the process shown above. Cloning Campaigns and Buzzes is extremely productive and useful in leveraging best practices especially when marketing to multiple locations. The system achieves Cloning with the following steps, upon selecting the Clone icon, item 312, the Software, item 152 in FIG. 3 sends instructions to the Server, item 151 which triggers programs to create a unique set of database identifiers for all required elements then register them in the Database of the Server, item 151 and the related operating units such as Software, Unified Metric System, Template Cloud and any Integrated Systems respectively items 152, 160, 156 and 158.

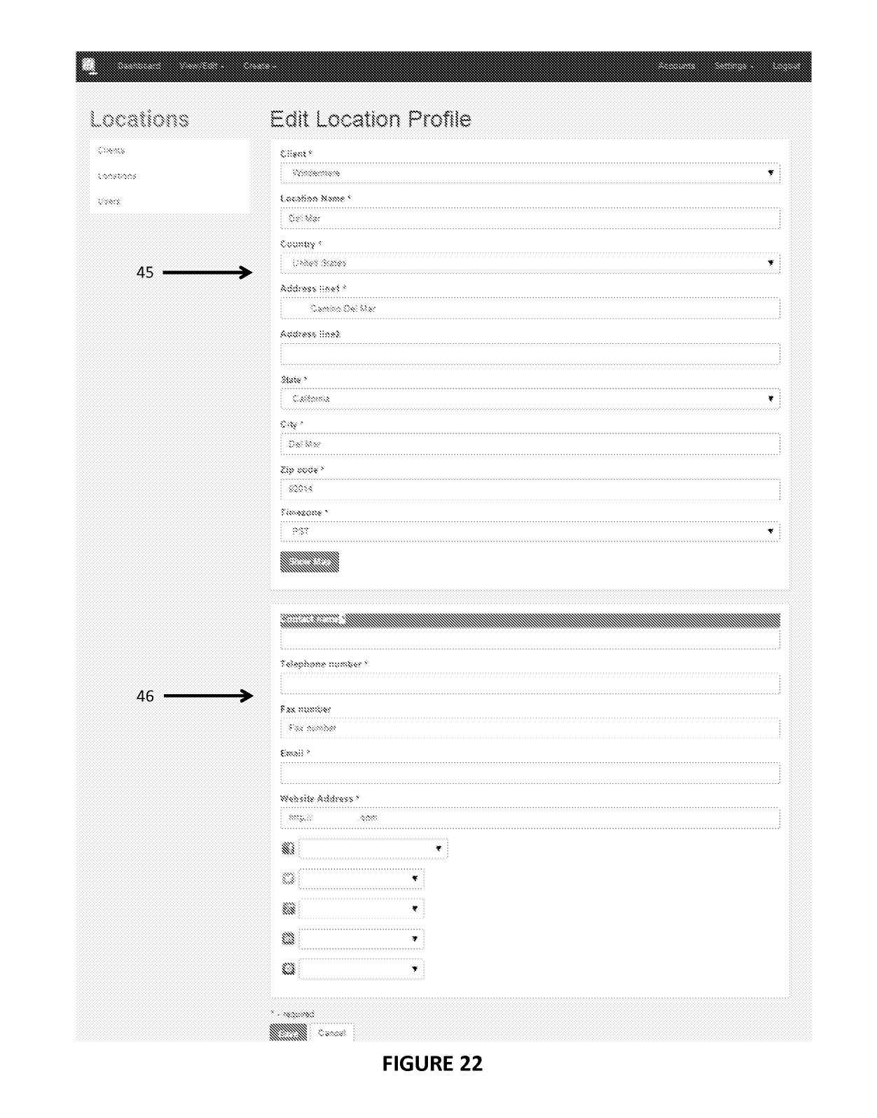

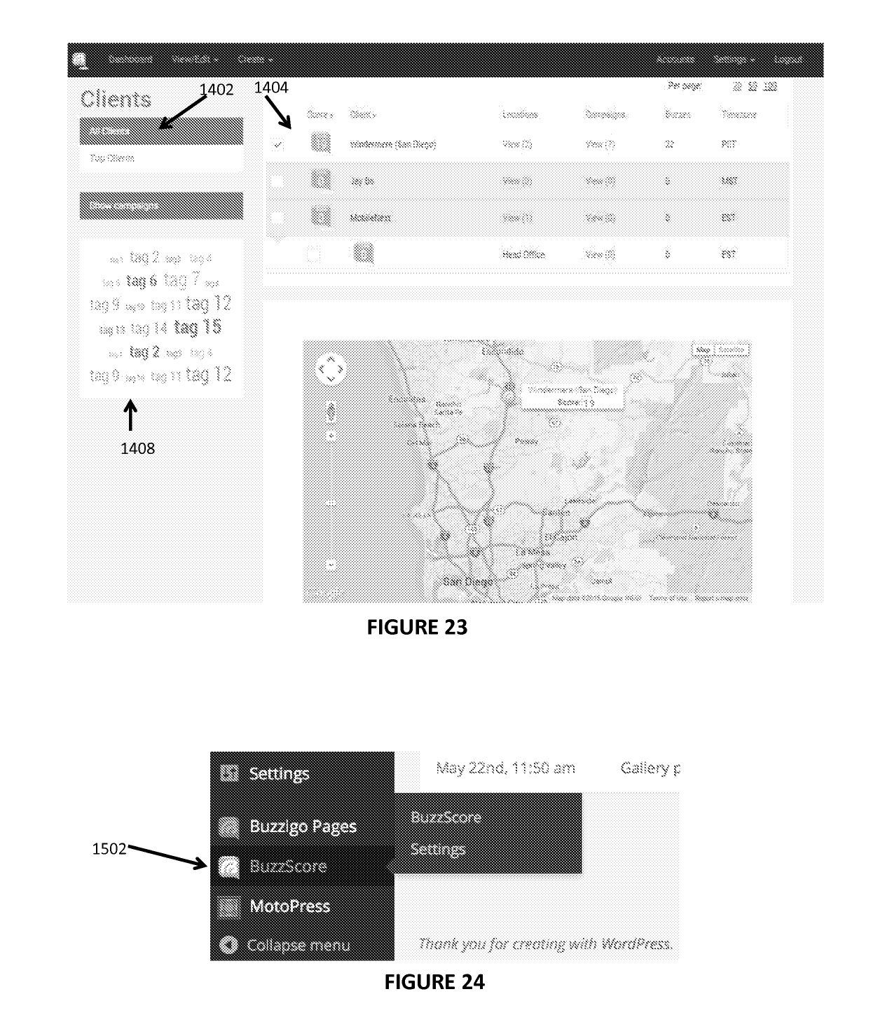

Locations profiles in FIG. 22 are related to act of Cloning FIG. 9 items 312 and 316 in that the Cloned content may contain programmatic instructions to query the Location Profile in FIG. 22 for Location specific data in items 45 and 46. Location specific data typically includes such data as addresses, phone numbers, images, Social Networks, email address and the like. In addition to replicating data programmatic operations can be used which in enhances value beyond efficiency. An example of a programmatic operation would be to perform a Geo-Location function from a Smartphone or Tablet type device such as displaying a Map with the address of the Brand Location pined via the address found in the Location Profile and the location of the User (Smart Phone and Tablet), or using a local phone number for click to call functionality. To achieve this the Software of FIG. 3, item 152 receives an instruction set from item 156 based on Followers item 162 observing and interacting with the Landing page, item 156. The Server then responds to the instruction set by accessing the required Location Profiles in the database of item 151 and executes the assigned sub-routine or operations such as Geo-Location, Mapping, Click to Call and the like.

To add a location one would highlight Locations, item 1202 in FIG. 21, then select Add Location, item 1203 and fill in the form shown in FIG. 22. Locations, Clients and Users are set up in the software by using similar steps in the Dashboard screen of FIG. 21. The results of these actions are a set of instructions sent to the Software of FIG. 3 item 152 which triggers actions by the Server 151 to establish the settings and unique database identifiers for creating Locations, Client, Users and the like from the Dashboard in item 153.

Once a new campaign is established the next steps, in general, are to follow FIG. 1 where one would create a Buzz item 104, select a social network item 106 and designate a Landing page, create a social message item 108, post the Buzz immediately or schedule it for a later time or times and dates via the steps of item 110. Once a Buzz is posted, item 112 the system automatically collects user actions item 116 from within the social network and thru to any associated Landing pages.

There are multiple ways to create a Buzz for a Campaign. FIG. 12 shows a quick method for creating a Buzz inside the Campaign you want the Buzz to be posted. Simply select the Buzz+ icon shown in item 502 and the Add Buzz, item 504 form will appear with the Buzz name automatically generated, it can be renamed if you wish to any unique name the system allows. Complete the form, item 506 by choosing the Social Network, generate a message, optionally add an image and Landing page then Post Now or Schedule the post for another time or times. The Buzz will then be shown as in FIG. 9, Campaigns Dashboard line, item 308 which begins with an icon of the social network the Buzz is to be published to followed by the BuzzScore, Name, Client, Run dates and status. To open and see the content of the Buzz one would mouse over the Name which displays a link, click on it and the Buzz will be shown as in item 310.

FIG. 2 shows a pictorial view of a full marketing campaign that a recipient or Follower of the Brand would see. Item 132 shows the Social Post which contains a social message followed by a URL link to the Landing page item 132a plus an image item 134 which could also be a video which was selectively included in the social post. The look and feel of this social post is specific to the Social Network the Buzz was posted to, in this illustration Facebook was posted too. When the URL link, item 132a is clicked the Landing page is displayed to the user and automatically provisioned for optimum viewing based on the type of device being used such as a Smart Phone in item 136 or Tablet 138 or desktop (not shown) connected to the internet via wire or wirelessly. The effectiveness of the Campaign is displayed by item 139, the BuzzScore which ranks effectiveness from 0 to 100. The BuzzScore is calculated realtime based on user actions across all content during the run time of the Buzz.

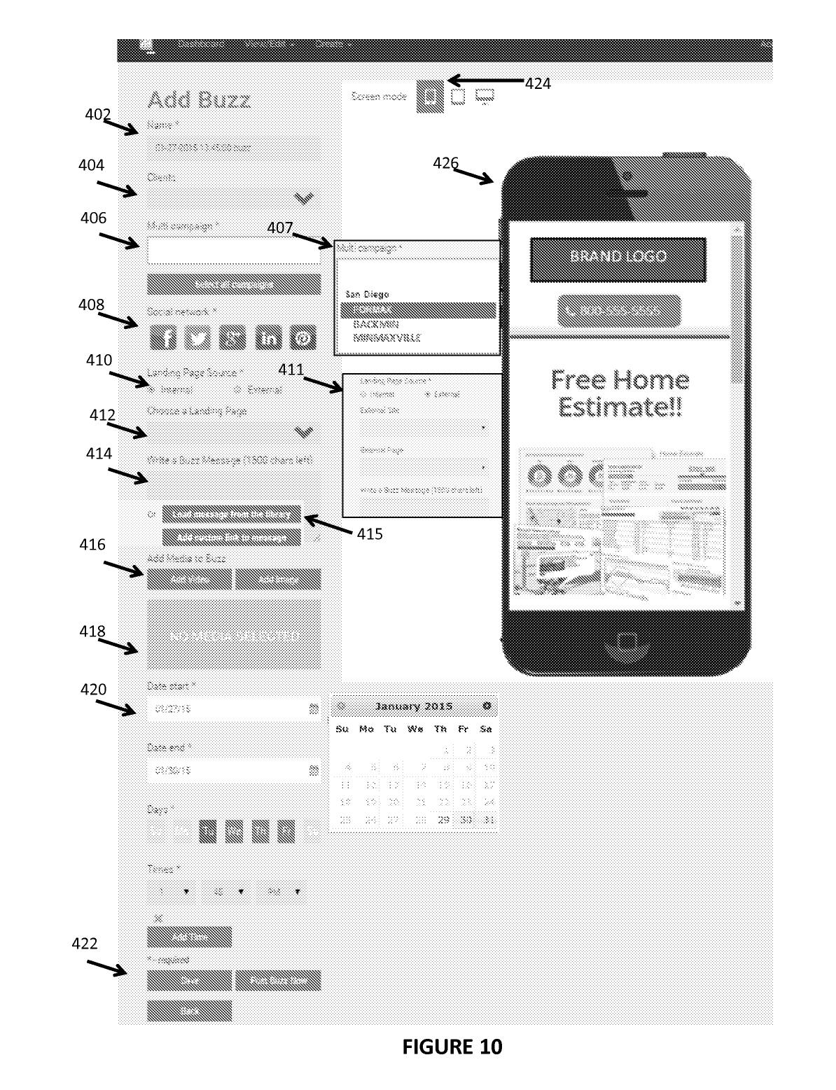

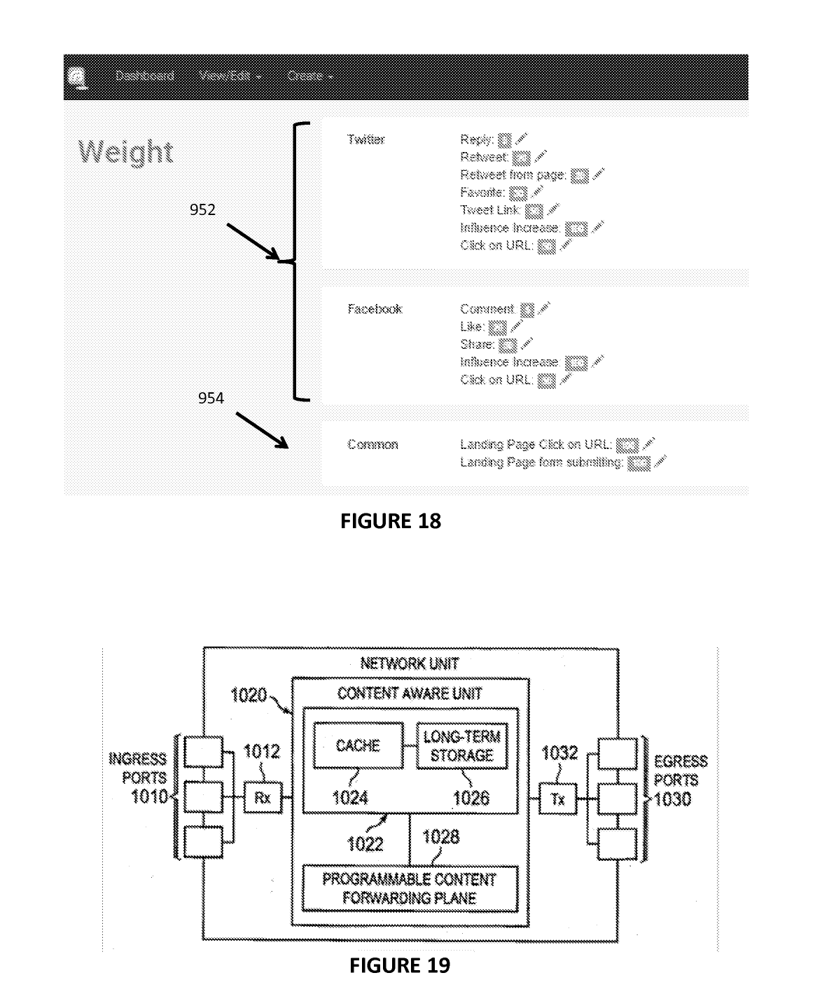

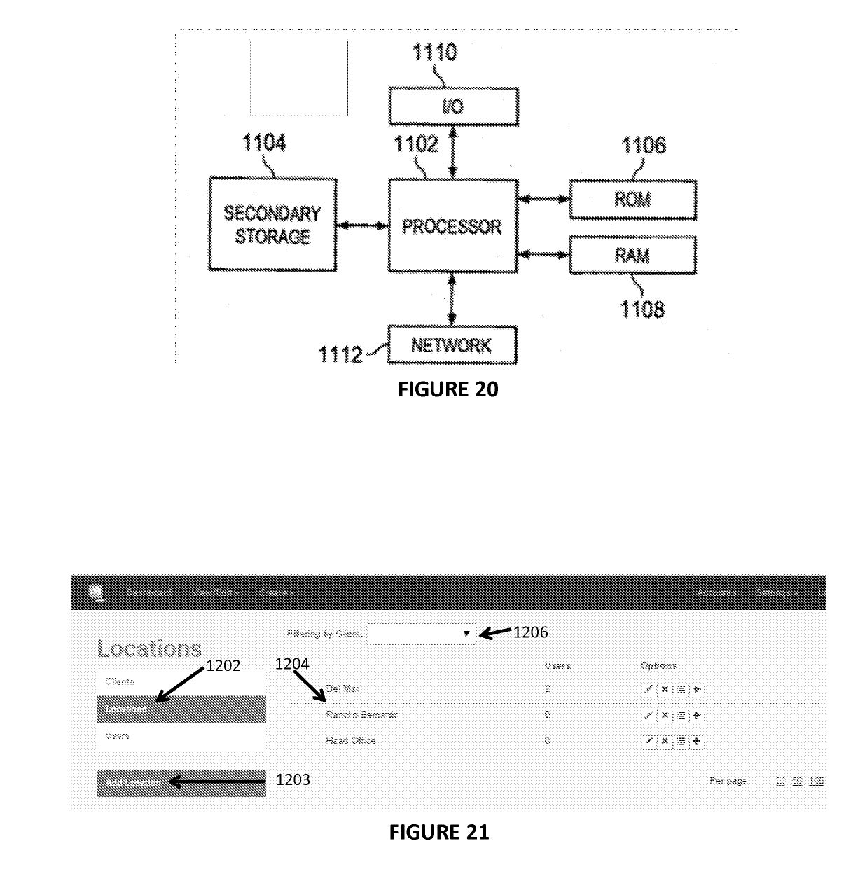

As described above, once a Campaign is established, Buzzes can be set up to be posted to Social Networks item 154, over the internet/Cloud at the appropriate scheduled time, per Location and Time Zone, via the Software and Server of FIG. 3 respectively item 152 and 151. The steps of which can include user establishing content, settings and saving a Buzz via the process of FIG. 10 items 402 through item 422 then the Software of FIG. 3, item 152 creates and registers the Buzz its unique identifiers of all elements in the database, item 151 and into other processing units such as the Scheduling module, Unified Metrics and the like. When it is time for a posting event the Software, item 152 sends instructions to the Server, item 151 which together with the Software item 152 calls the API of the appropriate Social Network in item 154 which triggers instructions to send the Social Post, as constructed, via the Social Network to Followers of the Brand. The Followers, item 162, may use any internet connected device whether wire or wireless to receive the Social Post, which may appear similar to FIG. 2 item 132 depending on the Social Network, item 154 in this case Facebook. Follower actions within the Social Media post, item 132 and the URL link, item 132a, to the associated Landing pages and their content are tracked by the Unified Metric system, item 160. Follower actions which are tracked can include the frequency or number of clicks and nature of specific Social Network routines and or actions such as ‘a like’ or ‘share’ which can broadcast Campaign content to unknown Followers of the registered Follower of the Brand. Follower interactions with the Buzz content are put against a value matrix as shown in FIG. 18 items 952 and item 954 that exist for each Buzz and or Landing page within item 160 and 152 respectively. These metrics are continuously calculated and rolled up to several levels starting at the Buzz and continuing to Campaigns, Locations, Clients and Partners. The BuzzScore is continuously calculated during the life of the Buzz or Campaign so that a real time effectiveness rating can be monitored. The rating is referred to as the BuzzScore, which ranges from 0 to 100 and is posted within the Dashboard, item 153. Other standard marketing metrics are calculated by the Unified Metrics such as Reach, Engagement, and Conversion.

FIG. 10 shows another method and steps for creating a Buzz which is often used for creating and assigning the Buzz to one or more locations. From menu 224 one would choose the Create pull down menu then Buzz. The Add Buzz screen as shown in FIG. 10 appears with the Buzz name automatically generated item 402 would be displayed. One would then simply follow the menu from top to bottom to create the Buzz which starts by selecting a client from the pull down menu of item 404, then in item 406 select one or more Campaign(s) the Buzz is to be assigned to. The framed graphic insert, item 407 illustrates the dialog box would look like with multiple campaign names. You could also choose to the ‘Select all campaigns’ button which would assign the Buzz to all active campaigns for the Client. Next the Social Network (s) item 408 is chosen which are denoted by a frame when selected. As Networks are selected one will note that the character control count shown in item 414 will update based on the social network selected. This also accounts for the length of the automatically generated URL used for the Landing page if selected. When multiple Networks are selected the character control will be limited to the lowest character account allowed. In the Landing page section one would designate the source by selecting either Internal or External as shown in item 410. With Internal selected, item 410 the next step is to choose a Landing page in item 412 which would display in the preview section item 426 for the device selected in item 424. As different devices are selected in item 424 the view automatically updates and shows the landing page as it would appear on the actual device. If External Landing page Source is selected in item 410, then the user would select the External Site containing the Landing page and the External Page as shown in item 411. The Disclosures Plug-in is used to link externally created Landing pages. Continuing on to the step as illustrated in item 414 one would insert or create a message to be posted to the social network these messages can be controlled to come only from a message library item 415 or both. Libraries are desirable because it aids in providing companywide consistent and acceptable messages plus it facilitates and coordinated marketing messages throughout multiple locations. Below this menu is a function for adding a custom URL to some other content which would be shown as a URL in the Social post.

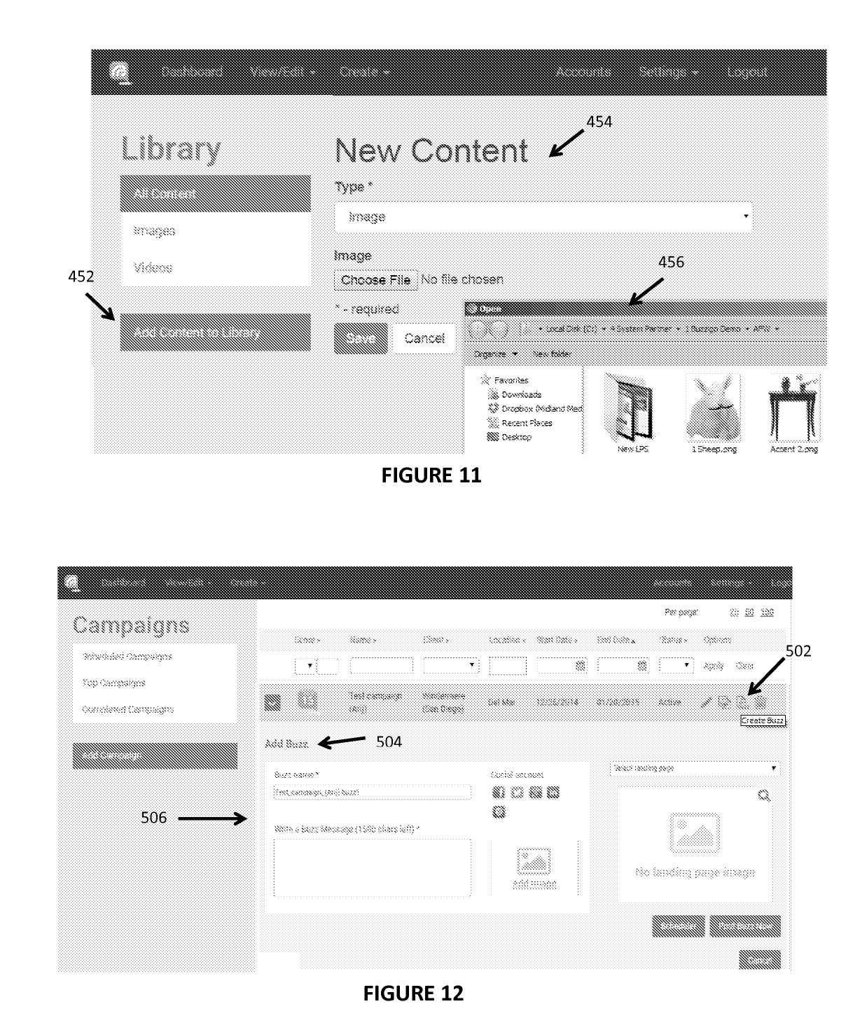

Item 416 shows the section where users can optionally add Media, images or videos, to the social media post. This can be loaded from a web based library, local computer, or the Disclosure has the ability to procure images from other websites which is desirable in many settings such as retail that are promoting new items from a manufacturer. This feature allows a customer such as a Retailer to procure the image assets directly and automatically from their manufacturer's website. Libraries in the Disclosure have maintenance functions such as remove and change images. If media is selected a preview of it is shown in item 418. FIG. 11 shows the Library screen that is accessed through the View/Edit pull down menu then selecting Library.

Scheduling of the Buzz takes place in the section indicated by 420, where the Buzz run time is scheduled for a day or more using the calendar. Posting Buzzes can be configured in various ways, set times of day, multiple posts per day via the Add Time button, intervals of days or weeks or months are all supported by the Disclosure. Each Buzz has its own independent schedule of days and times to post out with periods that maximize participation from followers of the social media network one is posting to. Buzz can be posted NOW as indicated in 422 and saved.

The computer operations that create the Buzz as described above and in FIG. 10 items 402 through item 422, follow these steps and methods. Upon the event of Create/Buzz, FIG. 5 item 214, the Software of FIG. 3, item 152 sends instructions to the Server item 151 to create a unique name and reserve it in the database of Server item 151 and Software item 152. At this juncture the full structure of a Buzz is reserved but essentially without data. The User of the system would complete item 402 through to item 420. The settings are held in a temporary state per the Buzz database structure in the System item 151. Upon selecting Save or Post Buzz Now, FIG. 10 item 422 the settings made by the User, would be permanently saved and registered to one or more Campaigns, Locations, Clients and Partner and all related content, tracking codes established and linked to and with operational units such as the Unified Metric System, Template Cloud and Software which are items 160, 156, and 152 respectively.

The run time of a Campaign is automatically determined and is based on the posting times of the Buzzes plus a settable period of time to capture user interaction. For example the start of a Campaign would be equal to the time that the first Buzz is posted to a social network and the end date is equal to the time of the last post of the last Buzz in the Campaign plus a settable period where residual user interaction is captured ie 2 days after the last post. As Buzzes are added to the System FIG. 3, item 151 and Software, item 152, the start and end dates of the Campaign are adjusted accordingly by the Software executing a sub-routine to calculate the new start and end based on all Buzzes assigned to the Campaign and where multiple locations are involved the dates would be adjusted based on time zones in the Location Profiles FIG. 22 item 45.

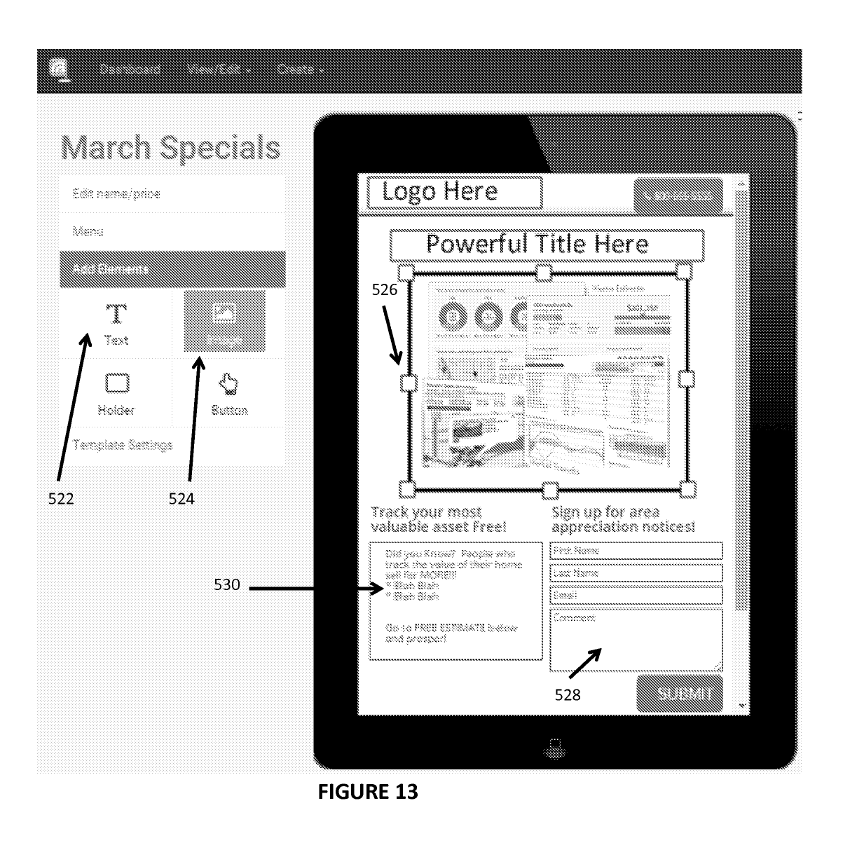

Landing pages are single page websites as shown FIG. 13 that contain a combination of images, video item 526 and text item 530. Together this content is designed to invoke a Call-to-Action by the viewer. Such a Call to Action could be the completion of an enquiry form, clicking a click-to-call icon to initiate a telephone call, or entering an email address to opt-in to a mailing list 528.

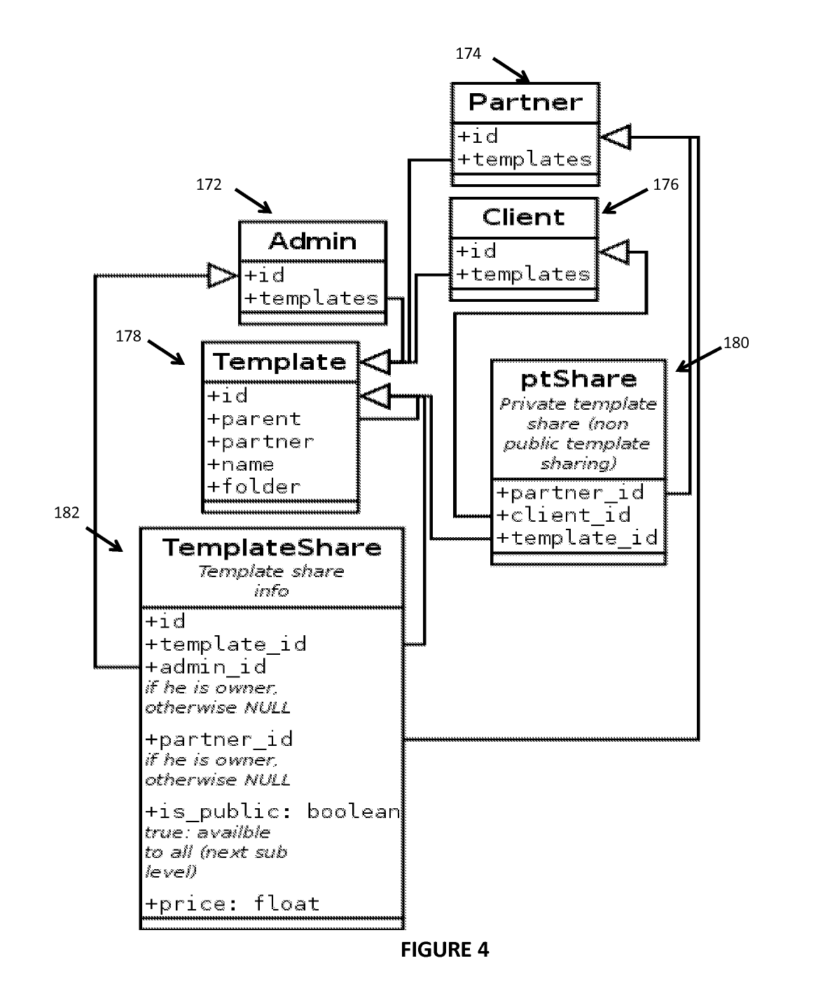

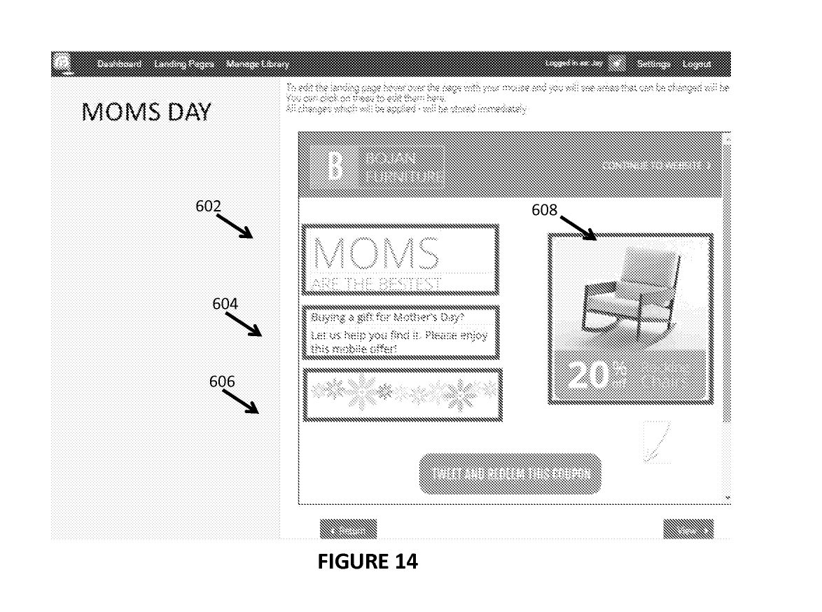

To create a landing page in the Disclosure, a standard user must select a pre-designed landing page Template that presents both the structure and content of the landing page that will be used such as in FIG. 14. The systems Template Cloud, FIG. 4, then creates a copy of the selected Template and saves it as an independent landing page structure that is then linked using a unique ID back to the user. Templates and Landing pages use a hierarchy of permissions via a widget that controls all editing rights. Typically the Landing page Editor FIG. 13 has similar widgets item 522 to the Template Editor but fewer options and permissions. To maintain content and brand control mechanisms, Templates can only be created or edited by user types who have either Admin or Partner access levels to the system. Only Partners can create new Templates, although Admins have the right to create new Templates on behalf of a specific Partner. Once created, Templates can then be assigned to specific Client(s). Each user type (Admin item 172/Partner item 174/Client item 176) is assigned a unique ID as well as a record of which Templates are associated with their ID.

Newly created Templates are stored in a centralized network repository called the Template Cloud. Each Template item 178 element stored in the Template Cloud is assigned a Unique ID, and stores the name of the Template parent (if it was copied from an existing Template), the name of the partner it was created by or on behalf of by an Admin, the name of the Template and the cloud folder where it is stored. If either an Admin or Partner wants to create or copy a Template but with some layout differences a new instance of that Template is created in the Template Cloud, with a new unique ID. An Admin or a Partner can then modify the new instance of the Template only. This new instance of the Template stores a unique ID that identifies both the parent Template and new owner of the Template (if the Template belongs to the Partner). All layout elements in the new Template instance, including all values/attributes/parameters are copied along with the new instance of the Template so that either Admin or a Partner can edit the actual layout of the new instance. The Hierarchy of Permissions of FIG. 28 is seamlessly integrated into the Template Cloud, for example, Admins item 185 are able to share Templates to Partners item 186. Partners are able to share Templates to Clients item 187 and make them available on paid basis as indicated in FIG. 4 item 182.

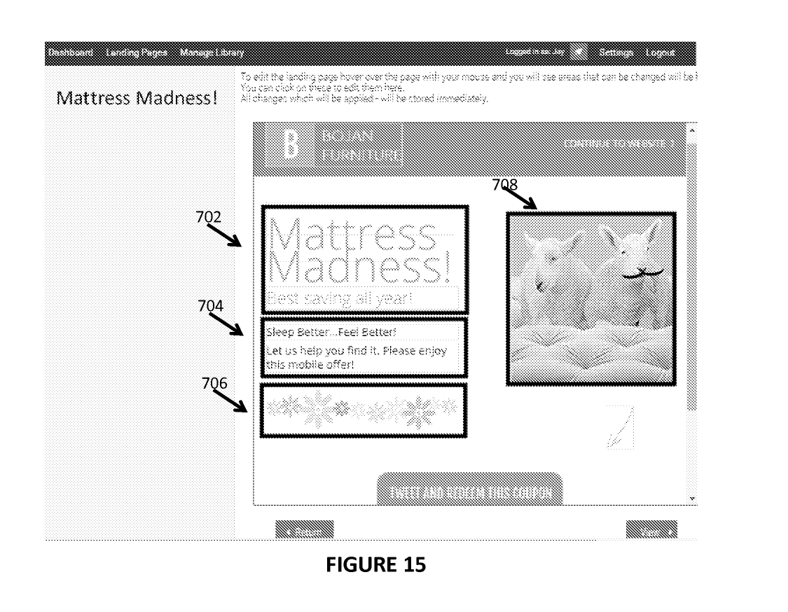

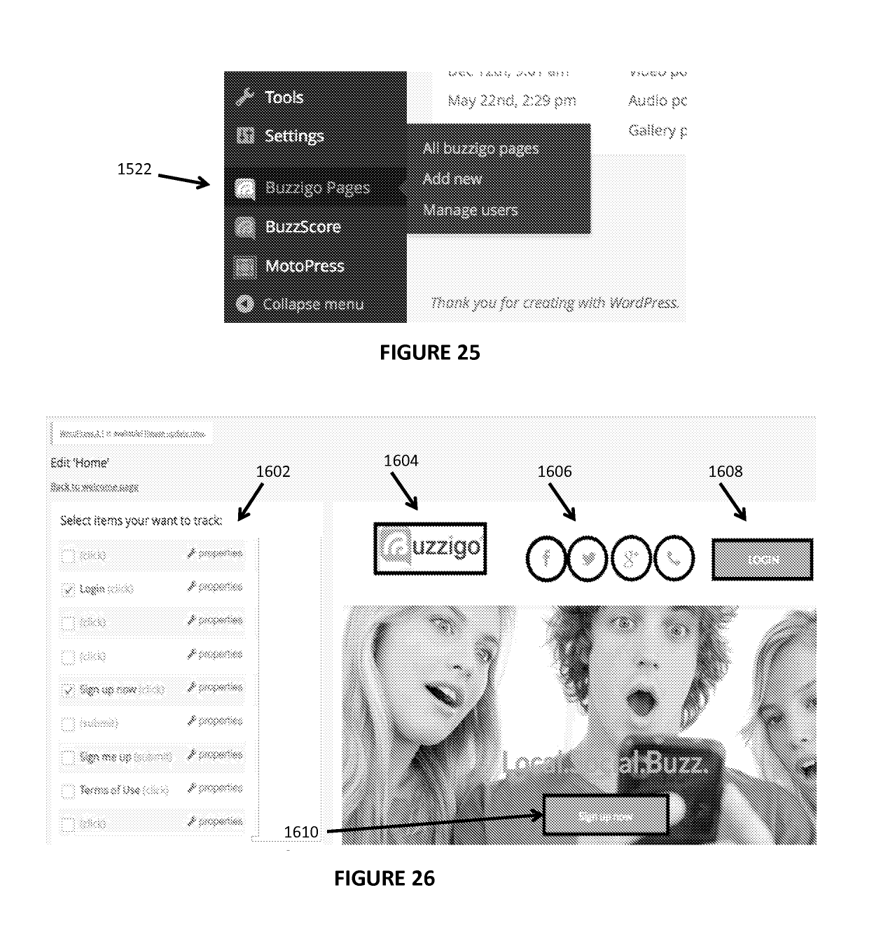

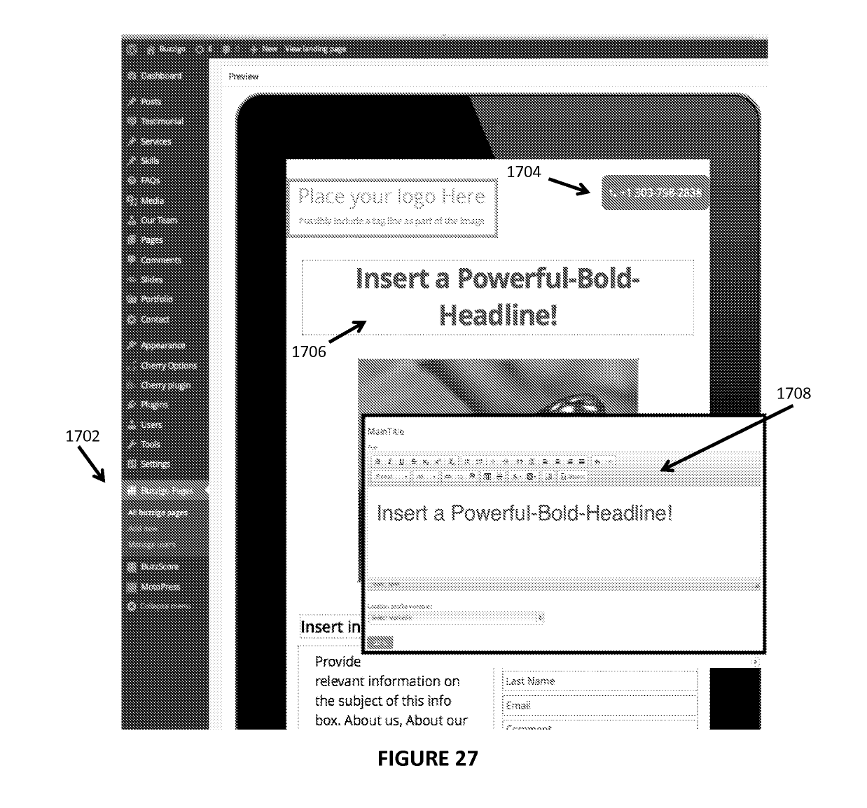

If either an Admin or Partner wants to share a Template, permissions are defined within the Template Share structure item 182 associated with that Template item 178. Templates can be shared either publically (to all Clients of that Partner) or privately. When Templates are shared privately, the ptShare table, item 180 is used to determine which Partner or Client has access to a specific Template ID. In case the Template needs to be available to specific sub-level users only, certain extra entities will appear in ptShare table item 180 defining who has access and whether it is a paid or free Template Landing page. Templates as shown in FIG. 13 are used to build Internal Landing pages specific to Campaigns using drag and drop technology where item 526 shows drag and sizing handles for the image that was dragged into the Landing page. Elements such as text item 530, images item 524, forms item 528, colors, stylizing and more can be used to build Landing pages. Landing page Templates contain the structure for Campaign Landing pages with predetermined brand control, programmatic routines such as the process of submitting a form to an email or database, integration with other systems which Clients and Users can repurpose as shown in FIGS. 14 and 15. If a customer uses a certain web platform such as WordPress the Disclosure's Landing page Plug-in can be used. From FIG. 25 one would select an existing Landing page Template from item 1522, Buzzigo Pages then All Buzzigo Pages. The system then presents the Landing page with framed elements items 1604, 1606, 1608 and 1610 as shown in FIG. 26 which are designated as editable. This is very similar to the editing process described in FIGS. 14 and 15. If a new Landing page is added elements to be tracked must be identified by selecting the BuzzScore Settings menu as shown by FIG. 24 item 1502. The system then automatically creates a list of elements to be tracked, as shown in FIG. 26 where 1604 through 1610 are designated in some manner often framed, then the user selects which items for the BuzzScore system to track by checking the item as shown in 1602. The Software of FIG. 3 item 152 sends instructions to Server 151 to establish the tracking codes and relationships in the appropriate operating modules conforming to the Hierarchy of Permissions.

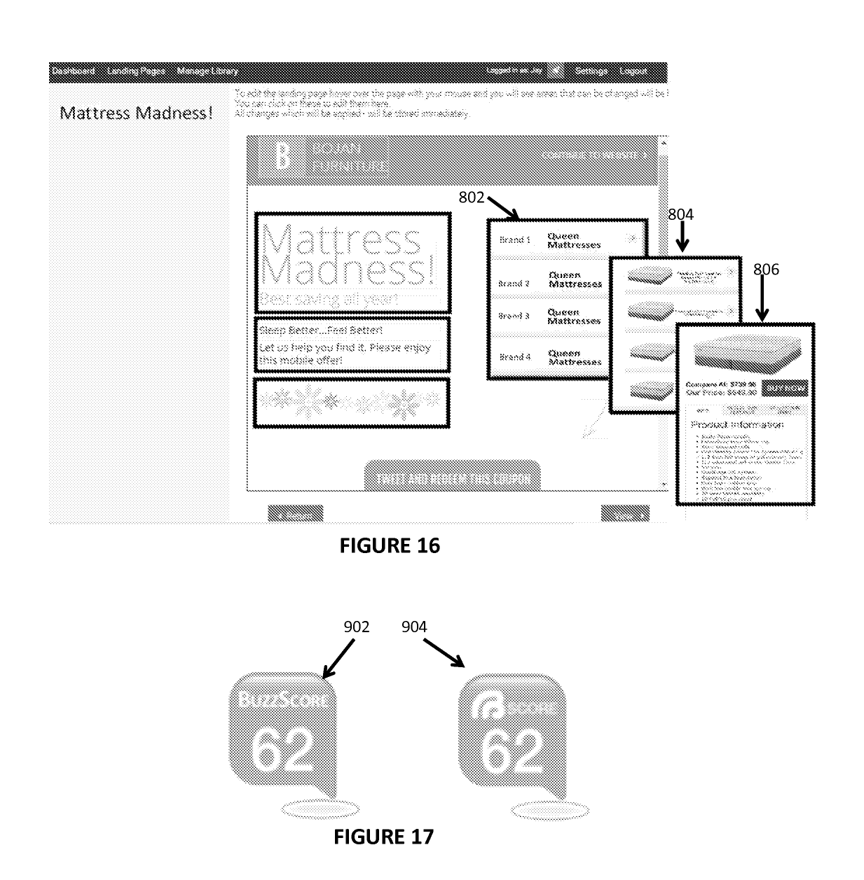

The software of the Disclosure can uniquely and automatically build and deploy complete Campaigns, Buzzes with Landing pages from data feeds of other systems as note in FIG. 3 item 158; namely eCommerce, sales and marketing systems, multiple listing for real estate and various operational data systems. This is achieved through use of API integration and or data feeds using RSS, JSON, XML and the like plus programmatic functions and stylizing the data using practices such as HTML 5 and CSS. The cascading windows depicted in FIG. 16 item 802, 804 and 806 illustrates the flexibility provided of the data feeds by changing from a static image of FIG. 15 item 708 to real time browsing that integration can provide. A user can now browse thru multiple vendor offerings from the robust data in the back end system plus advanced functionality such as Buy Now options are available which elevates the value and conversion to action versus a static picture. This function combined with the integration of social media networks to landing pages with dynamic data feeds and an effectiveness score is novel and desirable because it increases the ability to monetize social media marketing campaigns.

FIG. 18 illustrates an embodiment of a network unit 10, which may be any device that transports and processes data through network 10. For instance, the network unit 10 may correspond to or may be located in any of the system nodes described above, such as the device or server described as above, for example, the controller, nodes and branches as described above. The network unit 10 may correspond to or may be located in any of the system nodes described above. The network unit 10 may also be configured to implement or support the schemes and methods described above. The network unit 10 may comprise one or more ingress ports or units 1010 coupled to a receiver (Rx) 1012 for receiving signals and frames/data from other network components. The network unit 10 may comprise a content aware unit 1020 to determine which network components to send content to. The content aware unit 1020 may be implemented using hardware, software, or both. The network unit 10 may also comprise one or more egress ports or units 1030 coupled to a transmitter (Tx) 1032 for transmitting signals and frames/data to the other network components. The receiver 1012, content aware unit 1020, and transmitter 1032 may also be configured to implement at least some of the disclosed schemes and methods above, which may be based on hardware, software, or both. The components of the network unit 10 may be arranged as shown in FIG. 18.

The content aware unit 1020 may also comprise a programmable content forwarding plane block 1028 and one or more storage blocks 1022 that may be coupled to the programmable content forwarding plane block 1028. The programmable content forwarding plane block 1028 may be configured to implement content forwarding and processing functions, such as at an application layer or L3, where the content may be forwarded based on content name or prefix and possibly other content related information that maps the content to network traffic. Such mapping information may be maintained in one or more content tables (e.g., CS, PIT, and FIB) at the content aware unit 1020 or the network unit 10. The programmable content forwarding plane block 1028 may interpret user requests for content and accordingly fetch content, e.g., based on meta-data and/or content name (prefix), from the network or other content routers and may store the content, e.g., temporarily, in the storage blocks 1022. The programmable content forwarding plane block 1028 may then forward the cached content to the user. The programmable content forwarding plane block 1028 may be implemented using software, hardware, or both and may operate above the IP layer or L2.

The storage blocks 1022 may comprise a cache 1024 for temporarily storing content, such as content that is requested by a subscriber. Additionally, the storage blocks 1022 may comprise a long-term storage 1026 for storing content relatively longer, such as content submitted by a publisher. For instance, the cache 1024 and the long-term storage 1026 may include Dynamic random-access memories (DRAMs), solid-state drives (SSDs), hard disks, or combinations thereof.

The network components described above may be implemented on any general-purpose network component, such as a computer or network component with sufficient processing power, memory resources, and network throughput capability to handle the necessary workload placed upon it. FIG. 19 illustrates a typical, general-purpose network component 11 suitable for implementing one or more embodiments of the components disclosed herein. The network component 11 includes a processor 1102 (which may be referred to as a central processor unit or CPU) that is in communication with memory devices including secondary storage 1104, read only memory (ROM) 1106, random access memory (RAM) 1108, input/output (I/O) devices 1110, and network connectivity devices 1112. The processor 1102 may be implemented as one or more CPU chips, or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RAM 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104.

I claim:

1) A method of operating a social media marketing campaign platform using a server, comprising the steps of:
creating, scheduling, conducting and managing social media marketing campaigns whereby metrics are captured and analyzed for effectiveness across campaign content to one or more social networks from a single system;
building responsive landing pages;
identifying track-able web elements for use with an internal unified metric system with a value matrix for calculating an effectiveness score;
procuring and sharing content using an Application Program Interface (API) with an ability to automatically build and deploy campaigns from a set of user instructions or programmatic operations;
automatically duplicating, distributing and deploying the campaign content to multiple locations where location specific data and time zone management is seamlessly updated without manual intervention; and
displaying information on a centralized dashboard for monitoring, orchestrating and administrating performance aspects of the campaigns.

2) The method as specified in claim 1, wherein the landing page contains brand control functions limiting an ability of users to change brand related content.

3) The method as specified in claim 1, further comprising the step of enabling plug-ins for other landing page builders to integrate with the campaign content and metric system.

4) The method as specified in claim 1, further comprising the step of using location profiles to source location specific data for programmatic update of the campaign content.

5) The method as specified in claim 1, further comprising the step of providing content from approved libraries.

6) The method as specified in claim 1, further comprising the step of sending an alert to users that the campaign content is scheduled for deployment but not yet in an active or approved state.
A computer readable medium including instructions executable by a server having a

7) The method as specified in claim 1, further comprising the step of approving the campaign content prior to its deployment.

8. The method as specified in claim 1, wherein a centralized dashboard seamlessly presents content to users based on the specifications within a permissions matrix.

9) The method as specified in claim 1, further comprising the step of white labeling for rebranding purposes.

10) processor, including:
instructions for creating, scheduling, conducting and managing social media marketing campaigns whereby metrics are captured and analyzed for effectiveness across campaign content to one or more social networks from a single system;
instructions for building responsive landing pages;
instructions for identifying track-able web elements for use with an internal unified metric system with a value matrix for calculating an effectiveness score;
instructions for procuring and sharing content using an Application Program Interface (API) with an ability to automatically build and deploy campaigns from a set of user instructions or programmatic operations;
instructions for automatically duplicating, distributing and deploying the campaign content to multiple locations where location specific data and time zone management is seamlessly updated without manual intervention; and
instructions for displaying information on a centralized dashboard for monitoring, orchestrating and administrating performance aspects of the campaigns.

11) The computer readable medium as specified in claim 10, wherein the landing page contains brand control functions limiting an ability of users to change brand related content.

12) The computer readable medium as specified in claim 10, further comprising instructions for enabling plug-ins for other landing page builders to integrate with the campaign content and metric system.

13) The computer readable medium as specified in claim 10, further comprising further comprising instructions for using location profiles to source location specific data for programmatic update of the campaign content.

14) The computer readable medium as specified in claim 10, further comprising further comprising instructions for providing content from approved libraries.

15) A computer readable medium as specified in claim 10, further comprising further comprising instructions for sending alerts to users that the campaign content is schedule for deployment but not yet in an active or approved state.

16) The computer readable medium as specified in claim 10, wherein comprising further comprising instructions for approving the campaign content prior to its deployment.

17) The computer readable medium as specified in claim 10, wherein a centralize dashboard seamlessly presents content to users based on the specifications within a permissions matrix.

18) The computer readable medium as specified in claim 10, further comprising further comprising instructions for white labeling for rebranding purposes.

19) A method of operating a social media marketing campaign platform using a server, comprising the steps of:
creating, scheduling, conducting and managing social media marketing campaigns whereby campaign content is deployed to one or more social networks from a single system;
building responsive landing pages for the marketing campaign; and
displaying information on a centralized dashboard indicating performance characteristics of the marketing campaign.

20) The method as specified in claim 19, wherein the landing page contains brand control functions limiting an ability of users to change brand related content.

21) The method as specified in claim 19, further comprising the step of enabling plug-ins for other landing page builders to integrate with the campaign content and a metric system.

22) The method as specified in claim 19, further comprising the step of identifying and tracking of web elements unifying a metrics of the campaign content and creating a performance score.

23) The method as specified in claim 19, further comprising the steps duplicating, distributing and deploying the campaign content to multiple locations where location specific data and time zone management is seamlessly updated without manual intervention;

24) The method as specified in claim 23, wherein a location profile sources location specific data for programmatic update of the campaign content.

25) The method as specified in claim 19, further comprising the step of providing content from approved libraries.

26) The method as specified in claim 19, further comprising the step of sending alerts to users that the campaign content is scheduled for deployment but not yet in an active or approved state.

27) The method as specified in claim 19, further comprising the step of approving the campaign content prior to its deployment.

28) The method as specified in claim 19, wherein a centralize dashboard seamlessly presents content to users based on the specifications within a permissions matrix.

29) The method as specified in claim 19, further comprising the step of white labeling for rebranding purposes.
